(19) United States
(12) Patent Application Publication
(10) Pub. No.: US 2013/0011752 A1
(43) Pub. Date: Jan. 10, 2013

(54) METAL OXYGEN BATTERY

(75) Inventors: Kiyoshi TANAAMI, Saitama (JP); Satoshi NAKADA, Saitama (JP); Yuji ISOGAI, Saitama (JP); Takuya TANIUCHI, Saitama (JP)

(73) Assignee: HONDA MOTOR CO., LTD., Tokyo (JP)

(21) Appl. No.: 13/541,714

(22) Filed: Jul. 4, 2012

(30) Foreign Application Priority Data
Jul. 5, 2011 (JP) 2011-149351
Jul. 3, 2012 (JP) 2012-149236

(51) Int. Cl. H01M 12/08

(52) U.S. Cl. 429/405

(57) ABSTRACT

There is provided a metal oxygen battery which uses an oxygen-storing material of a composite oxide containing YMnO₃ as a positive electrode material, and can reduce the charge overpotential. The metal oxygen battery 1 has a positive electrode 2 using oxygen as an active substance, a negative electrode 3 using metallic lithium as an active substance, and an electrolyte layer 4 interposed between the positive electrode 2 and the negative electrode 3. The positive electrode 2 contains an oxygen-storing material of YMnO₃ and a reducing catalyst.

### BACKGROUND OF THE INVENTION

1. Field of the Invention

The present invention relates to a metal oxygen battery.

2. Description of the Related Art

Metal oxygen batteries have conventionally been known, which have a positive electrode using oxygen as an active substance, a negative electrode using a metal as an active substance, and an electrolyte layer interposed between the positive electrode and the negative electrode.

In the metal oxygen batteries, in the discharge time, a metal is oxidized to form metal ions at the negative electrode, and the formed metal ions permeate through the electrolyte and migrate into the positive electrode side. On the other hand, at the positive electrode, oxygen is reduced to form oxygen ions, and the formed oxygen ions bond with the metal ions to form a metal oxide.

In the charge time, at the positive electrode, metal ions and oxygen ions are formed from the metal oxide, and the formed oxygen ions are oxidized to become oxygen. On the other hand, the metal ions permeate through the electrolyte and migrate into the negative electrode side, and reduced to become the metal at the negative electrode.

In the metal oxygen battery, if metallic lithium is used as the metal, since the metallic lithium has a high theoretical potential and a large electrochemical equivalent weight, the metal oxygen battery can provide a large capacity. If oxygen in the air is used as the oxygen, since there is no need for filling a positive electrode active substance in a battery, the energy density per mass of the battery can be raised.

However, if the positive electrode is exposed to the atmosphere in order to make oxygen in the air to be a positive electrode active substance, moisture, carbon dioxide and the like in the air invade in the battery, and there is caused a problem of deterioration of the electrolyte, the negative electrode and the like. Then, in order to solve the problem, a metal oxygen battery is known, which has a positive electrode containing an oxygen-occluding material to release oxygen by reception of light, a negative electrode composed of metallic lithium, and an electrolyte layer disposed in a hermetically sealed case, and has a light transmission part to guide light to the oxygen-occluding material (for example, see Japanese Patent Laid-Open No. 2009-230985).

The metal oxygen battery can release oxygen from the oxygen-occluding material by guiding light to the oxygen-occluding material through the light transmission part, and can provide oxygen as a positive electrode active substance without exposing the positive electrode to the atmosphere. Therefore, the deterioration of the electrolyte, the negative electrode and the like due to the invasion of moisture, carbon dioxide and the like into the battery can be prevented.

However, in the conventional metal oxygen battery, the supply of oxygen becomes unstable in the absence of irradiation of light rays, and there is a risk that the light transmission part, which is weaker than other parts of the hermetically sealed case, is broken and the electrolyte solution leaks out. Then, it is conceivable that an oxygen-storing material which does not rely on irradiation of light rays and can occlude and release oxygen chemically, or adsorb and desorb oxygen physically is used as a positive electrode material of the metal oxygen battery. The oxygen-storing material includes YMnO₃.

However, in a metal oxygen battery using an oxygen-storing material composed of YMnO₃ as the positive electrode material, the charge overpotential becomes high, resulting in disadvantages that the charge and discharge efficiency decreases and a high power output cannot be attained.

### SUMMARY OF THE INVENTION

It is an object of the present invention to eliminate such disadvantages and provide a metal oxygen battery which uses an oxygen-storing material comprising YMnO₃ as a positive electrode material and whose charge overpotential can be decreased.

The present inventors have studied causes of the charge overpotential becoming high when an oxygen-storing material comprising YMnO₃ is used as a positive electrode material of a metal oxygen battery. As a result, it has been found that since YMnO₃ does not act as a reducing catalyst though having a function as an oxidizing catalyst, the reaction hardly progresses in which metal ions and oxygen ions are formed from a metal oxide at a positive electrode in the charge time.

The present invention has been achieved based on the finding; and in order to achieve the above-mentioned object, in a metal oxygen battery comprising a positive electrode to which oxygen is applied as an active substance, a negative electrode to which metallic lithium is applied as an active substance, and an electrolyte layer interposed between the positive electrode and the negative electrode, the positive electrode contains an oxygen-storing material comprising YMnO₃ and a reducing catalyst.

In the metal oxygen battery according to the present invention, in the discharge, metallic lithium is oxidized to form lithium ions and electrons at the negative electrode as shown in the following formula, and the formed lithium ions permeate through the electrolyte layer and migrate into the positive electrode. On the other hand, at the positive electrode, oxygen released or desorbed from the oxygen-storing material is reduced to form oxygen ions, and the formed oxygen ions react with the lithium ions to form lithium oxide or lithium peroxide. Then, by connecting the negative electrode and the positive electrode by a lead wire, an electric energy can be taken out.

(Negative Electrode) 4Li→4Li⁺+4e⁻

(Positive Electrode) O₂+4e→2O²⁻
a. 4Li⁺+2O²⁻→2Li₂O
b. 2Li⁺+2O²⁻→Li₂O₂

In the charge time, lithium ions and oxygen ions are formed from lithium oxide or lithium peroxide at the positive electrode as shown in the following formulae, and the formed lithium ions permeate through the electrolyte layer and migrate into the negative electrode. The formed oxygen ions are occluded or adsorbed as they are or as oxygen molecules formed by oxidation of the oxygen ions in or on the oxygen-storing material. At the negative electrode, the lithium ions are reduced and deposit as metallic lithium.

(Positive Electrode) 2Li₂O→4Li⁺+2O²⁻
a. Li₂O₂→2 Li⁺+2O²⁻

(Negative Electrode) 4Li⁺+4e⁻→4Li

Here, the metal oxygen battery according to the present invention contains the oxygen-storing material and together the reducing catalyst in the positive electrode. Then, in the charge time, the action of the reducing catalyst promotes the reaction in which lithium ions and oxygen ions are formed from lithium oxide or lithium peroxide at the positive electrode. Therefore, the metal oxygen battery according to the present invention can decrease the charge overpotential.

In the metal oxygen battery according to the present invention, the reducing catalyst includes at least one metal selected from the group consisting of Pd, Rh, Ru, Pt and Ir, or at least one compound selected from the group consisting of free radical-TEMPO, benzoquinone, polyaniline and phthalocyanine. The reducing catalyst is especially preferably Pd, and is advantageous in promotion of the reaction in which lithium ions and oxygen ions are formed from lithium oxide or lithium peroxide.

Also in the metal oxygen battery according to the present invention, the reducing catalyst may comprise at least one compound selected from the group consisting of palladium oxide, platinum oxide and gold oxide.

In the metal oxygen battery according to the present invention, the positive electrode may comprise the oxygen-storing material comprising YMnO₃, the reducing catalyst, a conductive material and a binder, and may further contain a lithium compound. The lithium compound includes, for example, lithium oxide and lithium peroxide.

In the case where the positive electrode comprises the oxygen-storing material comprising YMnO₃, the reducing catalyst, the conductive material, the binder, and the lithium compound, lithium ions formed at the positive electrode in the charge time deposit uniformly on metallic lithium of the negative electrode. Therefore, at the negative electrode, on repetition of dissolution and deposition of lithium, the lithium scarcely varies in its position, allowing the prevention of the formation of irregularities on the negative electrode surface and the suppression of a rise in the overpotential.

At this time, since the lithium compound closely contacts with the oxygen-storing material, the decomposition reaction of the lithium compound smoothly progresses due to a catalytic action of the oxygen-storing material. Therefore, the activation energy of the decomposition reaction of the lithium compound in the charge time can be reduced, allowing the further suppression of a rise in the overpotential.

In the metal oxygen battery according to the present invention, the reducing catalyst is preferably supported on the oxygen-storing material. At the positive electrode, although the reducing catalyst may be only simply mixed with the oxygen-storing material, the reducing catalyst being supported on the oxygen-storing material allows smooth migration of oxygen and electrons from the oxygen-storing material into the reducing catalyst, and can further decrease the charge overpotential.

Here, in the present application, “being supported on” refers to a state that the reducing catalyst and the oxygen-storing material are not present simply proximately or adjacently, but are chemically bonded.

In the metal oxygen battery according to the present invention, the positive electrode, the negative electrode and the electrolyte layer are preferably disposed in a hermetically sealed case. In the metal oxygen battery according to the present invention, the oxygen-storing material can chemically occlude and release or physically adsorb and desorb oxygen. Therefore, in the metal oxygen battery according to the present invention, oxygen as an active substance can be obtained at the positive electrode disposed in the hermetically sealed case instead of exposing the positive electrode to the atmosphere and forming a weak light transmission part, and there is no risk of the deterioration by moisture and carbon dioxide in the atmosphere and the leakage of an electrolyte solution by damage to the light transmission part.

Although in the case where the oxygen-storing material occludes and releases oxygen, the formation and dissociation of a chemical bond with oxygen is involved, in the case where oxygen is adsorbed on and desorbed from the surface, only an intermolecular force acts, and no formation and dissociation of a chemical bond is involved.

Therefore, the adsorption and desorption of oxygen on and from the surface of the oxygen-storing material is carried out with a lower energy than the case where the oxygen-storing material occludes and releases oxygen, and oxygen adsorbed on the surface of the oxygen-storing material is preferentially used in the battery reaction. Consequently, a decrease in the reaction rate and a rise in the overpotential can be suppressed.

### BRIEF DESCRIPTION OF THE DRAWINGS

FIG. 1 is an illustrative cross-sectional diagram showing one constitution example of the metal oxygen battery according to the present invention;

FIG. 2 is graphs showing charge and discharge curves in the metal oxygen battery according to one Example of the present invention; and

FIG. 3 is graphs showing charge and discharge curves in the metal oxygen battery according to another Example of the present invention.

### DETAILED DESCRIPTION OF THE PREFERRED EMBODIMENTS

Then, embodiments according to the present invention will be described in more detail by reference to accompanying drawings.

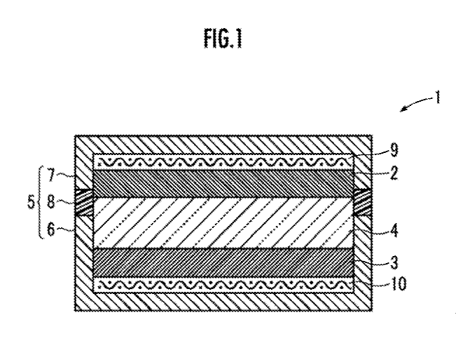

As shown in FIG. 1, a metal oxygen battery 1 according to the present embodiment comprises a positive electrode 2 using oxygen as an active substance, a negative electrode 3 using metallic lithium as an active substance, and an electrolyte layer 4 disposed between the positive electrode 2 and the negative electrode 3, and the positive electrode 2, the negative electrode 3 and the electrolyte layer 4 are hermetically accommodated in a case 5.

The case 5 comprises a cup-shape case body 6, and a lid body 7 to close the case body 6, and an insulating resin 8 is interposed between the case body 6 and the lid body 7. The positive electrode 2 has a positive electrode current collector 9 between the top surface of the lid body 7 and the positive electrode 2, and a negative electrode 3 has a negative electrode current collector 10 between the bottom surface of the case body 6 and the negative electrode 3. Here, in the metal oxygen battery 1, the case body 6 acts as a negative electrode plate, and the lid body 7 acts as a positive electrode plate.

In the metal oxygen battery 1, the positive electrode 2 may comprise a conductive material, a binder and a reducing catalyst, and may further contain a lithium compound. The lithium compound includes, for example, lithium oxide and lithium peroxide.

The oxygen-storing material comprises YMnO₃ and has a function of occluding and releasing oxygen, and can adsorb and desorb oxygen on and from the surface.

The conductive material includes, for example, carbon materials such as graphite, acetylene black, Ketjen Black, carbon nanotubes, mesoporous carbon and carbon fibers.

The binder includes polytetrafluoroethylene (PTFE) and polyvinylidene fluoride (PVDF).

The reducing catalyst includes at least one metal selected from the group consisting of Pd, Rh, Ru, Pt and Ir, or at least one compound selected from the group consisting of free radical-TEMPO, benzoquinone, polyaniline and phthalocyanine. The free radical-TEMPO (nitroxy radical) can be represented by the following general formula (1), and the polyaniline can be represented by the following general formula (2).

R₂N—2O (1)

—(C₆H₄—NH)ₙ— (2)

The reducing catalyst also may comprise at least one compound selected from the group consisting of palladium oxide, platinum oxide and gold oxide.

In the positive electrode 2, the reducing catalyst may be only simply mixed with the oxygen-storing material, but is preferably in proximity to the oxygen-storing material, and is more preferably supported on the oxygen-storing material.

Then, the electrolyte layer 4 may be, for example, one in which a nonaqueous electrolyte solution is immersed in a separator, or a solid electrolyte.

The nonaqueous electrolyte solution usable is, for example, one in which a lithium compound is dissolved in a nonaqueous solvent. The lithium compound includes, for example, carbonate salts, nitrate salts, acetate salts, lithium hexafluorophosphate (LiPF₆) and lithium bis(trifluoromethanesulfonyl)imide (LiTFSI). The nonaqueous solvent includes, for example, carbonate esteric solvents, etheric solvents and ionic liquids.

The carbonate esteric solvent includes, for example, ethylene carbonate, propylene carbonate, dimethyl carbonate and diethyl carbonate. The carbonate esteric solvent may be used as a mixture of two or more.

The etheric solvent includes, for example, dimethoxyethane, dimethyltriglyme and polyethylene glycol. The etheric solvent may be used as a mixture of two or more.

The ionic liquid includes, for example, salts of cations such as imidazolium, ammonium, pyridinium and piperidinium, with anions such as bis(trifluoromethylsulfonyl)imide (TTSI), bis(pentafluoroethylsulfonyl)imide (BETI), tetrafluoroborates, perchlorates and halogen anions.

The separator includes, for example, glass fibers, glass papers, polypropylene nonwoven fabrics, polyimide nonwoven fabrics, polyphenylene sulfide nonwoven fabrics, polyethylene porous films and polyolefin flat membranes.

The solid electrolyte includes, for example, oxide-based solid electrolytes and sulfide-based solid electrolytes.

The oxide-based solid electrolytes includes, for example, Li₇La₃Zr₂O₁₂, which is a composite oxide of lithium, lanthanum and zirconium, and glass ceramics containing lithium, aluminum, silicon, titanium, germanium and phosphorus as main components. The Li₇La₃Zr₂O₁₂ may be one in which another metal such as strontium, barium, silver, yttrium, lead, tin, antimony, hafnium, tantalum and niobium is substituted for a part of each of lithium, lanthanum and zirconium.

Then, the current collectors 9 and 10 includes ones composed of meshes of titanium, stainless steel, nickel, aluminum, copper or the like.

In the metal oxygen battery 1 according to the present embodiment, in the discharge time, metallic lithium is oxidized to form lithium ions and electrons at the negative electrode 3 as shown in the following formula. The formed lithium ions migrate into the positive electrode 2, and react with oxygen ions formed by reduction of oxygen supplied from the oxygen-storing material to form lithium oxide or lithium peroxide.

(Negative Electrode) 4Li→4Li⁺+4e⁻

(Positive Electrode) O₂+4e⁻→2O²⁻
a. 4Li⁺+2O²⁻→2Li₂O
b. 2 Li⁺+2O²⁻→Li₂O₂

On the other hand, in the charge time, lithium ions and oxygen ions are formed from lithium oxide or lithium peroxide at the positive electrode 2 as shown in the following formulae. The formed lithium ions migrate into the negative electrode 3 and are reduced at the negative electrode 3 to thereby deposit as metallic lithium.

(Positive Electrode) 2Li₂O→4Li⁺+2O²⁻
a. Li₂O₂→2 Li⁺+2O²⁻

(Negative Electrode) 4Li⁺+4e⁻→4Li

At this time, since the positive electrode 2 contains the reducing catalyst, the reaction in which lithium ions and oxygen ions are formed from lithium oxide or lithium peroxide is promoted by the reducing catalyst. The reaction is a dissociation reaction of a Li—O bond, and the reducing catalyst being present as microparticles in the interface between the oxygen-storing material and the conductive material can allow smooth transfer of electrons with respect to Li⁺ and O²⁻ after the dissociation. Consequently, the metal oxygen battery 1 can decrease the charge overpotential.

In the case where the reducing catalyst is composed of, for example, Pd, by mixing the oxygen-storing material with a palladium precursor such as palladium nitrate and calcining the mixture at a temperature of about 800° C., or by mixing the oxygen-storing material with a metallic Pd powder, the reducing catalyst can be made present in the interface between the oxygen-storing material and the conductive material.

Although in the oxygen-storing material in the discharge or the charge time described above, the occlusion and release of oxygen involves the formation and dissociation of a chemical bond, the adsorption and desorption of oxygen on and from the surface can be carried out only by an energy corresponding to an intermolecular force. Therefore, for the battery reaction at the positive electrode 2, oxygen adsorbed on and desorbed from the surface of the oxygen-storing material is preferentially used, allowing suppression of a decrease in the reaction rate and a rise in the overpotential.

Then, Examples and Comparative Examples are shown.

### EXAMPLE 1

In the present Example, first, yttrium nitrate pentahydrate, manganese nitrate hexahydrate and malic acid in a molar ratio of 1:1:6 were crushed and mixed to thereby obtain a mixture of a composite metal oxide material. Then, the obtained mixture of the composite metal oxide material was reacted at a temperature of 250° C. for 30 min, and thereafter further reacted at a temperature of 300° C. for 30 min and at a temperature of 350° C. for 1 hour. Then, the mixture of the reaction product was crushed and mixed, and thereafter calcined at a temperature of 1,000° C. for 1 hour to thereby obtain a composite metal oxide.

The composite metal oxide obtained was confirmed to be a composite metal oxide represented by the chemical formula YMnO₃ and have a hexagonal structure by an X-ray diffractometry pattern. The average particle diameter D50 of the obtained composite metal oxide was calculated by using a laser diffraction/scattering type particle size distribution measuring apparatus (made by HORIBA Ltd.) and using ethanol as a solvent, and the calculation revealed that the obtained composite metal oxide had an average particle diameter of 5.75 μm.

Then, the obtained YMnO₃ and a metallic palladium powder as a reducing catalyst were mixed by a ball mill to thereby obtain a YMnO₃ in which the metallic palladium powder as a reducing catalyst was mixed. The metallic palladium powder was added in a proportion of 20% by mass with respect to the total amount of the YMnO₃, and the mixing by the ball mill was carried out at 300 rpm for 60 min.

Then, the YMnO₃, Ketjen Black (made by Lion Corp.) as a conductive material, and a polytetrafluoroethylene (made by Daikin Industries, Ltd.) as a binder were mixed in a mass ratio of 10:80:10 to thereby obtain a positive electrode mixture. Then, the obtained positive electrode mixture was press bonded at a pressure of 5 MPa on a positive electrode current collector 9 composed of a titanium mesh to thereby form a positive electrode 2 of 15 mm in diameter and 1 mm in thickness. In the positive electrode 2, the metallic palladium powder as a reducing catalyst was microparticles, and was present in the interface between the YMnO₃ as a composite metal oxide and the Ketjen Black as a conductive material.

The positive electrode 2 was measured for the porosity by the mercury intrusion method using a fully automatic pore distribution measuring apparatus (made by Quantachrome Corp.), and the measurement revealed that the positive electrode 2 had a porosity of 78% by volume.

Then, a negative electrode current collector 10 of 15 mm in diameter composed of a copper mesh was arranged inside a bottomed cylindrical SUS-made case body 6 of 15 mm in inner diameter, and a negative electrode 3 of 15 mm in diameter and 0.1 mm in thickness composed of metallic lithium was superposed on the negative electrode current collector 10.

Then, a separator of 15 mm in diameter composed of a glass fiber (made by Nippon Sheet Glass Co., Ltd.) was superposed on the negative electrode 3. Then, the positive electrode 2 and the positive electrode current collector 9 obtained as described above were superposed on the separator so that the positive electrode 2 contacted with the separator. Then, a nonaqueous electrolyte solution was injected in the separator to thereby form an electrolyte layer 4.

As the nonaqueous electrolyte solution used was a solution (made by Kishida Chemical Co., Ltd.) in which lithium hexafluorophosphate (LiPF₆) as a supporting salt was dissolved in a concentration of 1 mol/L in a solvent. The solvent comprises a mixed solution prepared by mixing ethylene carbonate and diethyl carbonate in a mass ratio of 50:50.

Then, a laminate comprising the negative electrode current collector 10, the negative electrode 3, the electrolyte layer 4, the positive electrode 2, and the positive electrode current collector 9 accommodated in the case body 6 was closed by a bottomed cylindrical SUS-made lid body 7 of 15 mm in inner diameter. At this time, a ring-shape insulating resin 8 of 32 mm in outer diameter, 30 mm in inner diameter and 5 mm in thickness composed of a polytetrafluoroethylene (PTFE) was disposed between the case body 6 and the lid body 7 to thereby obtain a metal oxygen battery 1 shown in FIG. 1.

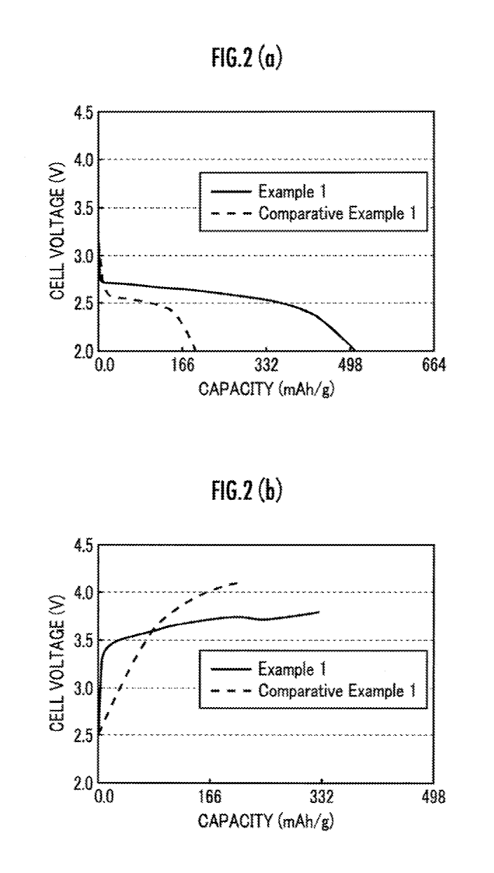

Then, the metal oxygen battery 1 obtained in the present Example was loaded on an electrochemical measuring apparatus (made by Toho Technical Research Co., Ltd.); and a current of 0.2 mA/cm² was applied between the negative electrode 3 and the positive electrode 2, and the discharge was carried out until the cell voltage became 2.0 V. The relationship between the cell voltage and the discharge capacity at this time is shown in FIG. 2(a).

Then, the metal oxygen battery 1 obtained in the present Example was loaded on the electrochemical measuring apparatus; and a current of 0.2 mA/cm² was applied between the negative electrode 3 and the positive electrode 2, and the charge was carried out until the cell voltage became 4.5 V. The relationship between the cell voltage and the charge capacity at this time is shown in FIG. 2(b).

### COMPARATIVE EXAMPLE 1

In the present Comparative Example, a metal oxygen battery 1 shown in FIG. 1 was manufactured wholly as in Example 1, except for using no metallic palladium powder at all as a reducing agent in the positive electrode 2.

Then, the charge and the discharge were carried out wholly as in Example 1, except for using the metal oxygen battery 1 obtained in the present Comparative Example. The relationship between the cell voltage and the discharge capacity in the discharge time is shown in FIG. 2(a), and the relationship between the cell voltage and the charge capacity in the charge time is shown in FIG. 2(b), respectively.

It is clear from FIG. 2 that the metal oxygen battery 1 of the Example containing the metallic palladium powder as a reducing catalyst in the positive electrode 2 had a larger discharge capacity and a lower charge overpotential than the metal oxygen battery 1 of the Comparative Example.

### EXAMPLE 2

In the present Example, a composite metal oxide material represented by the chemical formula YMnO₃ was obtained wholly as in Example 1.

Then, the obtained YMnO₃ was charged in a 0.19 mol/L palladium nitrate dihydrate solution, and the mixture was evaporated to dryness at a temperature of 120° C. using a hot stirrer. Then, the obtained solid was mixed and crushed in a mortar, and calcined at a temperature of 600° C. for 1 hour to thereby obtain a catalyst-supporting YMnO₃ on which a palladium oxide as a reducing catalyst was supported. The palladium oxide was supported in a proportion of 20% by mass with respect to the total amount of the YMnO₃.

Then, the catalyst-supporting YMnO₃, Ketjen Black (made by Lion Corp.) as a conductive material, a polytetrafluoroethylene (made by Daikin Industries, Ltd.) as a binder, and lithium peroxide (made by Kojundo Chemical Laboratory Co., Ltd.) as a lithium compound were mixed in a mass ratio of 8:1:1:4 to thereby obtain a positive electrode mixture. Then, the obtained positive electrode mixture was applied on a positive electrode current collector 9 composed of an aluminum mesh to thereby form a positive electrode 2 of 15 mm in diameter and 0.4 mm in thickness.

Then, a negative electrode current collector 10 of 15 mm in diameter composed of a SUS mesh was arranged inside a bottomed cylindrical SUS-made case body 6 of 15 mm in inner diameter, and a negative electrode 3 of 15 mm in diameter and 0.1 mm in thickness composed of metallic lithium was superposed on the negative electrode current collector 10.

Then, a separator of 15 mm in diameter composed of a polyolefin flat membrane (made by Asahi Kasei E-Materials Corp.) was superposed on the negative electrode 3. Then, the positive electrode 2 and the positive electrode current collector 9 obtained as described above was superposed on the separator so that the positive electrode 2 contacted with the separator. Then, a nonaqueous electrolyte solution was injected in the separator to thereby form an electrolyte layer 4.

As the nonaqueous electrolyte solution used was a solution (made by Kishida Chemical Co., Ltd.) in which lithium bis(trifluoromethanesulfonyl)imide (LiTFSI) as a supporting salt was dissolved in a concentration of 1 mol/L in a solvent which was dimethoxyethane.

Then, a laminate comprising the negative electrode current collector 10, the negative electrode 3, the electrolyte layer 4, the positive electrode 2, and the positive electrode current collector 9 accommodated in the case body 6 was closed by a bottomed cylindrical SUS-made lid body 7 of 15 mm in inner diameter. At this time, a ring-shape insulating resin 8 of 32 mm in outer diameter, 30 mm in inner diameter and 5 mm in thickness composed of a polytetrafluoroethylene (PTFE) was disposed between the case body 6 and the lid body 7 to thereby obtain a metal oxygen battery 1 shown in FIG. 1.

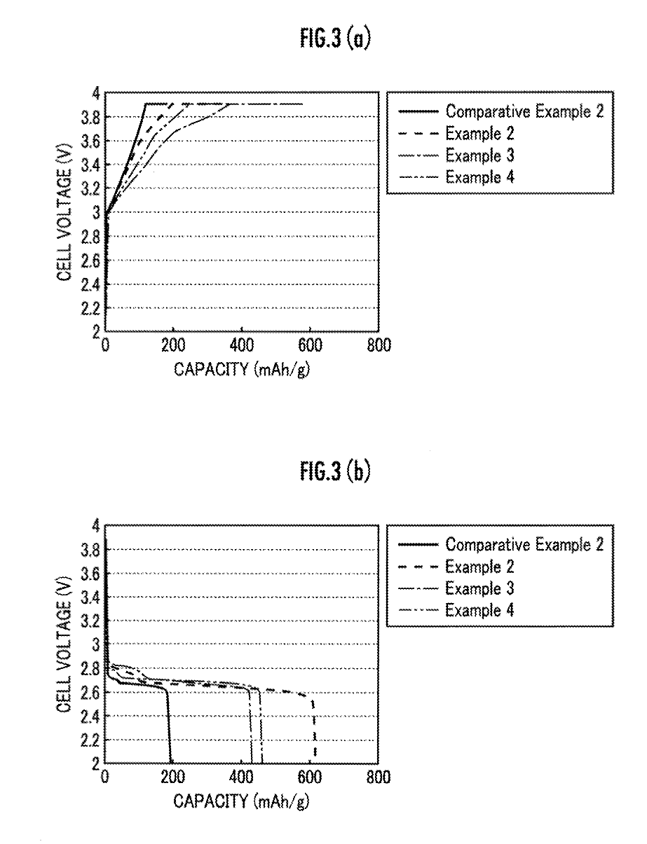

Then, the metal oxygen battery 1 obtained in the present Example was loaded on an electrochemical measuring apparatus (made by Toho Technical Research Co., Ltd.); and a current of 0.2 mA/cm² was applied between the negative electrode 3 and the positive electrode 2, and the constant-current charge was carried out until the cell voltage became 3.9 V. The charge was switched to the constant-voltage charge at the time when the cell voltage reached 3.9 V, and carried out until the current value became 0.015 mA/cm². The relationship between the cell voltage and the charge capacity at this time is shown in FIG. 3(a).

Then, the metal oxygen battery 1 obtained in the present Example was loaded on the electrochemical measuring apparatus; and a current of 0.2 mA/cm² was applied between the negative electrode 3 and the positive electrode 2, and the discharge was carried out until the cell voltage became 2.0 V. The relationship between the cell voltage and the discharge capacity at this time is shown in FIG. 3(b).

### EXAMPLE 3

In the present Example, first, a catalyst-supporting YMnO₃ on which a platinum oxide as a reducing catalyst was supported was obtained wholly as in Example 2, except for using a 0.10 mol/L hexachloroplatinic acid hexahydrate solution in place of the 0.19 mol/L palladium nitrate dihydrate solution. The platinum oxide was supported in a proportion of 20% by mass with respect to the total amount of the YMnO₃.

Then, a metal oxygen battery 1 shown in FIG. 1 was manufactured wholly as in Example 2, except for using the catalyst-supporting YMnO₃ obtained in the present Example.

Then, the charge was carried out wholly as in Example 2, except for using the metal oxygen battery 1 obtained in the present Example. The relationship between the cell voltage and the charge capacity at this time is shown in FIG. 3(a).

Then, the discharge was carried out wholly as in Example 2 except for using the metal oxygen battery 1. The relationship between the cell voltage and the discharge capacity at this time is shown in FIG. 3(b).

### EXAMPLE 4

In the present Example, a catalyst-supporting YMnO₃ on which a gold oxide as a reducing catalyst was supported was obtained wholly as in Example 2, except for using a 0.10 mol/L chloroauric acid tetrahydrate solution in place of the 0.19 mol/L palladium nitrate dihydrate solution. The gold oxide was supported in a proportion of 20% by mass with respect to the total amount of the YMnO₃.

Then, a metal oxygen battery 1 shown in FIG. 1 was manufactured wholly as in Example 2, except for using the YMnO₃ obtained in the present Example.

Then, the charge and the discharge were carried out wholly as in Example 2, except for using the metal oxygen battery 1 obtained in the present Example. The relationship between the cell voltage and the charge capacity in the charge time is shown in FIG. 3(a), and the relationship between the cell voltage and the discharge capacity in the discharge time is shown in FIG. 3(b).

### COMPARATIVE EXAMPLE 2

In the present Comparative Example, a metal oxygen battery 1 shown in FIG. 1 was manufactured wholly as in Example 2, except for using none of palladium oxide, platinum oxide and gold oxide at all as a reducing catalyst in the positive electrode 2.

The charge and the discharge were carried out wholly as in Example 2, except for using the metal oxygen battery obtained in the present Comparative Example. The relationship between the cell voltage and the discharge capacity in charge time is shown in FIG. 3(a) and the relationships between the cell voltage and the discharge capacity in discharge time is shown in FIG. 3(b).

It is also clear from FIG. 3 that the metal oxygen batteries 1 of Examples 2 to 4 containing any of palladium oxide, platinum oxide, and gold oxide as a reducing catalyst in the positive electrode 2 had larger discharge capacities and lower charge and discharge overpotentials than the metal oxygen battery 1 of Comparative Example 2.

What is claimed is:

1. A metal oxygen battery, comprising:
a positive electrode to which oxygen is applied as an active substance;
a negative electrode to which metallic lithium is applied as an active substance; and
an electrolyte layer interposed between the positive electrode and the negative electrode,
wherein the positive electrode comprises an oxygen-storing material comprising YMnO₃ and reducing catalyst.

2. The metal oxygen battery according to claim 1, wherein the reducing catalyst comprises at least one metal selected from the group consisting of Pd, Rh, Ru, Pt and Ir, or at least one compound selected from the group consisting of free radical-TEMPO, benzoquinone, polyaniline and phthalocyanine.

3. The metal oxygen battery according to claim 2, wherein the reducing catalyst comprises Pd.

4. The metal oxygen battery according to claim 1, wherein the reducing catalyst comprises at least one compound selected from the group consisting of palladium oxide, platinum oxide and gold oxide.

5. The metal oxygen battery according to claim 1, wherein the positive electrode comprises the oxygen-storing material comprising YMnO₃, the reducing catalyst, a conductive material, and a binder.

6. The metal oxygen battery according to claim 1, wherein the positive electrode comprises the oxygen-storing material comprising YMnO₃, the reducing catalyst, a conductive material, a binder, and a lithium compound.

7. The metal oxygen battery according to claim 6, wherein the lithium compound comprises lithium peroxide.

8. The metal oxygen battery according to claim 1, wherein the reducing catalyst comprises supported on the oxygen-storing material.

9. The metal oxygen battery according to claim 1, wherein the positive electrode, the negative electrode, and the electrolyte layer are disposed in a hermetically sealed case.
